(19) United States
(12) Patent Application Publication
(10) Pub. No.: US 2015/0199913 A1
(43) Pub. Date: Jul. 16, 2015

(54) METHOD AND SYSTEM FOR AUTOMATED ESSAY SCORING USING NOMINAL CLASSIFICATION

(71) Applicant: LightSide Labs, LLC, Pittsburgh, PA (US)

(72) Inventors: Elijah Jacob Mayfield, Pittsburgh, PA (US); David Stuart Adamson, Pittsburgh, PA (US)

(73) Assignee: LightSide Labs, LLC, Pittsburgh, PA (US)

(21) Appl. No.: 14/152,123

(22) Filed: Jan. 10, 2014

(51) Int. Cl. G09B 7/02

(52) U.S. Cl. CPC G09B 7/02

(57) ABSTRACT

A computer-implemented system for predicting a grade, score or other class value for an essay receives a corpus of training essays, wherein each essay is a response to a common prompt. For each training essay, the system receives a class value and extracts feature values for each of a group of features. The system then uses the information learned from the training essays to build a model by assigning a probability to each of various combinations of the class values and feature values. When the system then receives a candidate essay, it extracts a set of the feature values from the candidate essay and applies the model to the feature values extracted from the candidate essay to determine a probable class value for the candidate essay.

### BACKGROUND

The grading of written work product, such as student essays, is a time-and labor-intensive process. To address this problem, several systems have been proposed to perform automated essay grading. The standard approach of these systems has been to define a small set of expert-designed features that are highly correlated with essay quality. Examples of these features include essay length (in number of words) or text coherence. For each document, each feature in this predefined set is assigned a feature value, multiplied by a numeric coefficient, and the results for all features are summed in a linear regression.

These systems have generally been limited in their flexibility and have been constrained to regression tasks, where essays are assigned a real-valued numeric score. There are several limitations to this approach. For example, prior systems require a small set of curated features to be defined by experts prior to regression analysis, and thus are limited to the skills and domain understanding (and subject to the influence) of their human authors. In addition, prior systems require each feature to be assessed as either making an essay better or worse, dependent on whether the feature has a positive or negative weighting coefficient. Even for basic features, this is a simplistic assumption and can yield unintended results.

### SUMMARY

A system for predicting a grade, score or other class value for an essay receives a corpus of training essays, wherein each essay is a response to a common prompt. For each training essay, the system receives a class value and extracts feature values for each of a group of features. The system then uses the information learned from the training essays to build a model by assigning a probability to each of various combinations of the class values and feature values. When the system then receives a candidate essay, it extracts a set of the feature values from the candidate essay and applies the model to the feature values extracted from the candidate essay to determine a probable class value for the candidate essay.

Optionally, before building the model, the system may apply a filter to features for which feature values were extracted from the training essays to remove the features having feature values that do not satisfy a retention criterion. If so, the system may use only feature values for the non-removed features in the building step. When applying the filter, the system may remove features having feature values that are less than a threshold. The threshold may be a measure of a number of essays in the corpus that contain the feature, a percentage of the essays in the corpus that contain the feature, a chi-squared test statistic, or another suitable measurement. In some embodiments, building the model may include applying a Naïve Bayes classifier to assign the probabilities.

Optionally, when applying the model the system may assess candidate class values for the corpus of training essays, and for each value, determine a probability that the class value will appear in the corpus in combination with a particular feature value. The particular feature values may be those for features that were not removed in the filtering step. The system may then select the probable class value as the candidate class value having the highest determined probability. Additionally, the system may determine a confidence value for each probability. If so, it may select the probable class value as the candidate class value having the highest determined confidence value.

Optionally, when extracting the feature values from each training essay, the system may apply n-gram extraction to extract n-grams from text of each of the training essays, wherein n is an cardinal number, The system may then filtering the n-grams to yield a filtered n-gram set. If so, then when extracting the set of feature values from the candidate essay the system may, for each n-gram in the filtered n-gram set, determine whether the n-gram is present in the document, and assign a binary value to the n-gram for the candidate essay based on whether or not the n-gram is present. When assigning the probabilities, the system may use the binary value for each n-gram as the feature values.

### BRIEF DESCRIPTION OF THE DRAWINGS

FIG. 1 is a flow diagram illustrating examples of steps that may be performed when building a model based on a corpus of documents, and when applying the model to predict a class value for future documents.

FIG. 2 illustrates an example of various ways that an embodiment of the system may extract features from a corpus of documents.

FIG. 3 illustrates an example an example of how a classifier may assign predictions to various possible class values for a new document.

FIG. 4 illustrates an example of various hardware elements that may be used in the embodiments of this disclosure.

### DETAILED DESCRIPTION

As used in this disclosure, the singular forms “a,” “an,” and “the” include plural references unless the context clearly dictates otherwise. Unless defined otherwise, all technical and scientific terms used in this disclosure have the same meanings as commonly understood by one of ordinary skill in the art. As used in this disclosure, the term “comprising” means “including, but not limited to.”

When used in this disclosure, unless the context otherwise requires, the following nouns have the following meanings.

“Class” means a predefined, discrete set of possible outputs that can be associated with a document.

“Class label” means exactly one possible output from the set defined by a particular class.

“Class value” means a particular class label associated with a particular document.

“Classification algorithm” means a particular method of training a model given a corpus, a feature set, and feature values for each document within that corpus.

“Classifier” means an ensemble of components, comprising: (i) one or more extractors; (ii) a feature set generated from a particular corpus by those extractors; and (iii) a model that has been trained with that feature set on feature values from that corpus.

“Corpus” means a plurality of documents, each with an associated, predefined class value.

“Document” means a written text, prepared in response to a prompt, stored in electronic form. In the context of automated essay grading, the word “essay” is synonymous.

“Extractor” means a method that performs one or more of the following actions: (i) given a corpus, generates a feature set associated with that corpus; and (ii) given a particular document, assigns feature values associated with that document for each feature that is both present in the document and part of the document's corpus' associated feature set.

“Feature” means a unique, easily identifiable characteristic of a written text that, for a particular document, can be associated with a numeric value.

“Feature set” means a defined plurality of features.

“Feature value” means a numeric value associated with a particular feature in a particular document.

“Filter” means a method that selects a plurality of features from a feature set, of cardinality less than that of the original feature set, and discards all other features, preventing their use in a model either for training or predicting.

“Model” means a method, trained on a particular corpus and feature set, for predicting a class value associated with a document, given feature values associated with that document, where each feature value is associated with a feature in the training feature set.

“Prompt” means a particular stimulus that is presented to a person, made up of text, images, audio, video, and/or multiple media, where that person is expected to produce a written text document in response.

“Regression” means a method for assigning a numeric score to a document using a multivariate mathematical equation.

When used in this disclosure, unless the context otherwise requires, the following verbs have the following meanings:

“Building” means defining a classifier by, for example selecting a corpus, one or more extractors, and a classification algorithm; applying those extractors to that corpus, resulting in a feature set; and training a model using that classification algorithm and the feature values associated with that feature set for that corpus.

“Extracting” means, with respect to a particular document, analyzing the document to associate feature values for that document with each feature within a given feature set. With respect to a corpus of documents, “extracting” means analyzing the corpus of documents to identify features that comprise a feature set.

“Generating” means analyzing a corpus with one or more extractors, resulting in a feature set associated with that corpus.

“Predicting” means extracting feature values for a particular document and producing an output of probability estimations for each possible class value for a document.

“Training” means analyzing a corpus, wherein each document within that corpus has associated feature values for that feature set, and using a training algorithm to define a model.

This disclosure describes methods and systems that use machine learning to evaluate textual responses to a particular writing prompt. In this setting, a writer is presented with a stimulus. An example of such a stimulus is an essay question; other examples may include documents or multimedia artifacts to analyze. The writer then composes a document and receives an assessment of that text. The assessment may be, for example, a numeric score, grade or other class value. While such assessments are typically done by humans, this disclosure describes a method and system that produces assessments through machine learning. The system may assume a relatively small set of possible scores (which are a type of class value). For instance, a simple class might have two possible class values—Pass and Fail. In other examples, a class's labels may be a set of numeric values on an ordinal scale, for instance the set {1, 2, 3, 4, 5, 6}.

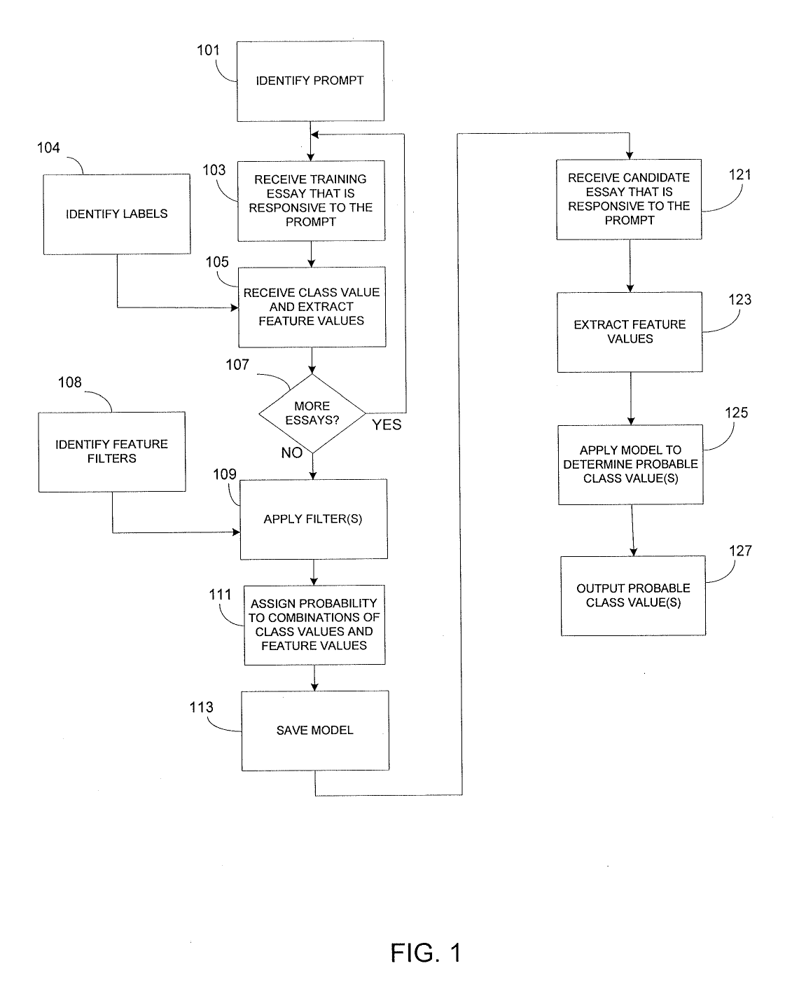

FIG. 1 is a flow diagram illustrating basic elements of a method of building an assessment model and using the model to determine class values for a set of essays. Referring to FIG. 1, the left side of the diagram describes an example of a model building process. The system may identify a prompt (step 101), either by generating the prompt itself or by receiving it from an external source. The system will then receive a training essay that is responsive to the prompt (step 103), identify a class value for the essay and extract feature values from the essay (step 105). An essay may be evaluated for multiple classes, each of which would have a class value. In addition, different essays may have different categories of class values. Because of this, before identifying the class values the system may first identify one or more labels (step 106) for the class values that it will receive. The system may receive the class value and feature values by extracting data from a document file, by receiving metadata or separate inputs that are associated with the document, or by analyzing the document through suitable methods such as optical character recognition (OCR).

The system will repeat the steps described above for additional essays until the system determines that no additional essays are available or required to build the model (step 107). The system may determine this based on any suitable criteria, such as the completion of analysis of a threshold number of essays, or the completion of analysis of all available documents in a corpus.

The system will then assign a probability (step 111) to each of a plurality of the possible class value/feature value combinations that it receives through the corpus analysis. The probabilities will serve as an element of a model for the training essay set. The system will then save the model (step 113) to a computer-readable memory so that it can be used to predict class values for new documents that are responsive to a similar prompt or same prompt. However, optionally before building the model, the system may define one or more feature filters (step 108) that are rules (i.e., retention criteria) by which the system will select features to ignore when correlating features to class values. The system will then apply the filters (step 109) to block or otherwise remove features that do not satisfy the retention criteria.

Various model building steps are described in more detail in the following paragraphs. In particular, the following sections of this document describe various methods that an essay classifier may use to collect training data by defining the prompt and building a training corpus, and to define machine learning settings by choosing a set of extractors, a classification algorithm, and any filters that will be used for building a model.

In the essay classifiers, the system may apply a classifier that is specific to a prompt. In other words, rather than applying generic models of language use, the constructed models will be prompt-specific so that they are then useful for predicting class values for candidate essays that are responsive to the same prompt as to the prompt to which the training corpus responded. Two prompts may be considered to the same if they are exactly the same (i.e., word for word), or substantially equivalent (i.e., they may use different words but have the same substance and meaning). The prompt should be focused enough that text responses have approximately the same (or at least similar) characteristics. These characteristics might include an estimated length (e.g., word count range) or complexity of the response text, and the topic should be well-defined so that writers can understand the type of essay that is expected of them. The system may automatically select the prompt may be selected from a data set of available prompts, or the system may receive the prompt from an external source, such as a user input or third party system.

The system will then receive and assess documents—i.e., answers, essays or other written material that is responsive to the prompt. While each answer should come with the same baseline expectations about the prompt, they may represent a variety of responses from a variety of users in various formats. This is in contrast to many other systems, which instead require a handful of “exemplar” answers. The predictive elements of the system may be improved if the documents in the training corpus include documents that vary in quality and writer skill level, such as including poor-quality, off-topic, and/or average essays in addition to excellent responses. The more closely this training corpus can approximate the range of responses is expected in the future, the more accurately a classifier will may be able to replicate human evaluation of those future responses.

Either simultaneously with the definition of a writing prompt or in parallel with data collection, a set of assessment evaluations may be developed. In simplest form, this could be a numeric range that holistically evaluates the quality of a written response to a particular prompt. However, in many cases these numeric ranges are not holistic but are instead assessing a written essay along a particular dimension, such as the clarity of a thesis statement or an indication of particular content mastery. In these cases, the human rating process should follow a written rubric, and the design and development of this rubric should be iterated until humans reach a high level of inter-rater reliability. Each of the possible assigned evaluations types—including a numeric assessment or a written rubric—may be considered to be a potential label for a class.

Once an assessment has been defined and training responses have been collected, the system will apply the assessment to each document in order to build a corpus for training a machine learning system. If scoring is holistic and based upon a numeric range, for instance, then each essay may be assigned a single numeric value, which could later be used as the class value for that essay response. If scoring is multidimensional, then each dimension could be labeled independently; scores need not be interdependent.

As will be discussed below, the system may generate predictions for essay scores using a classifier. Classifiers may include some or all of the following components: a corpus, a set of extractors, a set of filters, and a classification algorithm. The description up to this described a process of collecting a corpus. The next several paragraphs of this disclosure describe suitable processes of extraction and filtering.

Extractors are computer algorithms that may take as input a single text essay and produce an unordered set of the list of features that this text essay contains. Extractors also may identify feature sets that appear in a corpus of documents. The particular rules by which features are identified using an extractor (i.e., step 105 in FIG. 1) may vary based on the particular implementation of the system. Features are typically structural characteristics of a text, such as words, character strings or similar elements. Optionally, semantic analysis may be used so that semantically similar words are considered to be one and the same for the purpose of feature extraction. In other embodiments, features may be characteristics of structural elements, such as word size or sentence size. Depending on the rules, the number of features extracted by a single extractor from a single essay might range from as few as zero or one, to hundreds or thousands of features representing a single document. Any number of features may be identified, and in various embodiments the system does not need to assign weights to any of the features for the purpose of analysis. The rules may be established by manual operator selection, by a default rule set, by detecting a condition that triggers an automated selection of a rule set, any combination of these options and/or other methods.

In some embodiments, a feature value may be a numeric value, meaning that at an abstract level, an extractor's purpose is to convert a text into a set of labeled numeric values representing the contents of that text. A simple example of a feature is a count of the number of words in a text. This representation would use a numeric word count to represent the length of the essay. Additional examples will be described below.

The particular extractors applied to a document may be tailored to the task for which they are being used. For example, in the essay grading task, the conversion of a text document to a set of numeric values may produce information about the text that will allow a downstream classification algorithm to distinguish between different potential class values.

After extracting features from an entire training corpus, each document will have an associated set of features and feature values. However, in some embodiments this data may not be usable for training a model in its original form. For example, the system may require that to develop a model, the set of features must be uniform over an entire training corpus. Although all features may not be present in all documents, features that do not appear in all documents could be ignored, or the feature values for features that do not appear in a document could be set to zero. This is because many algorithms within machine learning, especially for text processing, are based in vector mathematics. Each feature may be represented as a column in a matrix; each essay text may be represented by a row (or vice versa). The cell at the intersection of a column and row in that matrix would therefore be the feature value for the corresponding column's feature and row's essay.

Based on this, generating a feature set may be an exercise in concatenation. All features that were extracted from all essays may be grouped into a single set. To fill in the resulting matrix, each essay's features may be used as columns. When two essays share a feature, they may share a corresponding column. For each feature contained in an essay, the corresponding intersection of row and column can be filled with that feature's value in that essay. All empty cells after this process have a value of 0. In some implementations, the representation of zero values is implicit due to memory constraints.

A series of filters is then applied to a feature set (step 109 in FIG. 1). These filters may be algorithmic, just as extractors may be algorithmic. Filters may take as input a training corpus and an already-extracted set of features. Based on the feature values contained within the essays in the training corpus, the filters cause the system to remove (i.e., ignore or discard) some number of features from final analysis. Conceptually, this is equivalent to deleting entire columns from the corresponding matrix. Note that filtering is an optional step; a classifier with zero filters is still a valid configuration.

Finally, after filtering, a classification algorithm learns a set of rules that map particular feature values to particular class labels. This algorithm then uses the training corpus to build a model (step 111).

The processes and elements described so far—prompt definition and evaluation, corpus collection and labeling, selection of feature extractors, feature filters, and a classification algorithm, and extracting features, filtering a feature set, and building a model from extracted feature values in a training corpus—may be considered to be part of a training process. The result is a classifier that associates features with class values. This object is then used to predict new labels and class values for new documents.

When using a classifier to predict the class value of a new text, the system will receive a candidate essay (or other document) that was prepared in response to the prompt (step 121), extract feature values from the document (step 123), and apply the model to those feature values to predict one or more class values for the document (step 125). Parameters that are equivalent to those used in training (i.e., the same parameters or substantially similar parameters) may be used on that new text. For example, some or all of the same extractors will be applied to the document to extract features, and these feature values are associated with the essay if and only if they are contained in the filtered feature set. The filtered features for the new text may then be processed by the trained model, which predicts a class value for the new text. The predicted class value, or optionally multiple class values, may be output (step 127), such as on a display or via an audio output of an electronic device, or to a data file that is stored in a memory and/or transmitted to a user. If multiple class values are output, they may be presented along with other information that indicates which predicted class values are more probable than others, such as in a ranked order based on determined confidence levels for each predicted value, or with the actual determined confidence levels themselves.

In many classification algorithms, this prediction may not merely choose a single class value. For example, the system may apply the Naïve Bayes algorithm to predict a class value by selecting several candidate class values and estimating probabilities for each candidate class value. This can alternatively be treated as a measure of confidence, with the most probable class value (or some other criterion) being used to select one of the candidate values as the predicted value, or the system may output multiple predictions with confidence values associated with each prediction. Alternatively, the probabilities may be collapsed into a single predicted class value (the most probable of all options). Other algorithms that do not assign probabilities to each class value, such as C4.5 decision trees, may be used. In these cases they may be treated as if probabilities exist. If so, their predicted class may be assigned a probability of 100% and all other class values may be assigned a probability of 0%. While this lopsided distribution may be non-standard, the system could implement such a treatment.

### Examples

Writing Prompts:

The system may use many possible writing prompts. For example, a typical prompt could be an essay question that is assigned to students in classrooms, on standardized tests, or in other learning environments. For example, the following prompt from a standardized test could be used: “Write a persuasive essay to a newspaper reflecting your vies on censorship in libraries. Do you believe that certain materials, such as books, music, movies, magazines, etc., should be removed from the shelves if they are found offensive? Support your position with convincing arguments from your own experience, observations, and/or reading.”

Writing prompts of this nature, at their shortest, may be a single sentence. They may also contain one or more excerpts or documents, such as the quote in the example above. These artifacts can be multimedia, such as images, audio, or video, and they may be quantitative, such as tables, graphs, or charts.

Creative writing prompts are also feasible. Examples of such prompts include:
1. A wife kills her husband. Make me sympathize with both characters.
2. You're about to be cloned, but before you are, the doctor says the clone will be tattooed to identify which one is the original. But after you wake up, you notice that *you* have the tattoo. What do you do/say/think?
3. Write a paragraph without the letter ‘e’.

In some situations, new prompts may be generated to correspond to a training corpus that was not originally written in a prompt-oriented setting. The following examples demonstrate this:

1. Write a letter in the style of a 19th-century governor of the British Empire.

2. Write a Wikipedia entry on the author of a book you've read recently.

In these cases, a training corpus can be collected from pre-existing texts written in the same genre. For instance, in the latter case, all literature articles on http://en.wikipedia.org were written with the implicit “prompt” described above, even if it was not presented as such in an essay assignment. Training documents can therefore be collected as if they were responding to that prompt.

Assigning Class Labels and Values:

In a simple case, a class may be a binary distinction, meaning that there are only two possible class values in this example. In the context of essay grading, this could be election from the labels {PASS, FAIL} or the labels {0, 1}.

With no modifications, this system can be applied to numeric scales with multiple values, such as {0, 1, 2, 3, 4}. Even though these values are ordered, the system need not consider the fact that some values could be “closer” than others—they are treated as independent possible class values. This means that the system may also generalize to other tasks, such as {RED, YELLOW, GREEN}, or predictions like {PERSUASIVE, INFORMATIVE, NARRATIVE}. This last prediction may include assessing the fit of an essay to a particular genre. The system may be flexible to either of these formats of output.

The system may apply algorithms that can be generalized to parallel predictions on rubric grades. For instance, a single rubric may be comprised of scales for CLARITY with a set of class labels {0, 1, 2, 3, 4}, ORGANIZATION with a set of class labels {PASS, FAIL}, and EVIDENCE with a set of class labels {0, 1, 2}. Here, the class labels are CLARITY, ORGANIZATION and EVIDENCE, and the possible class values for each class label are the listed bracketed options. In this situation three classifiers would be trained. There need not be any interdependency that forces multiple classifiers to predict from the same set of class labels for a new input document.

Feature Extraction:

One embodiment of feature extractors is the n-gram extractor. This type of extractor sets at least three parameters: (1) the source representation of the text; (2) the atomic granularity of the extracted features; and (3) the length of the extracted features, n. The text in a source essay is then sequentially processed and all possible features are generated based on those parameters.

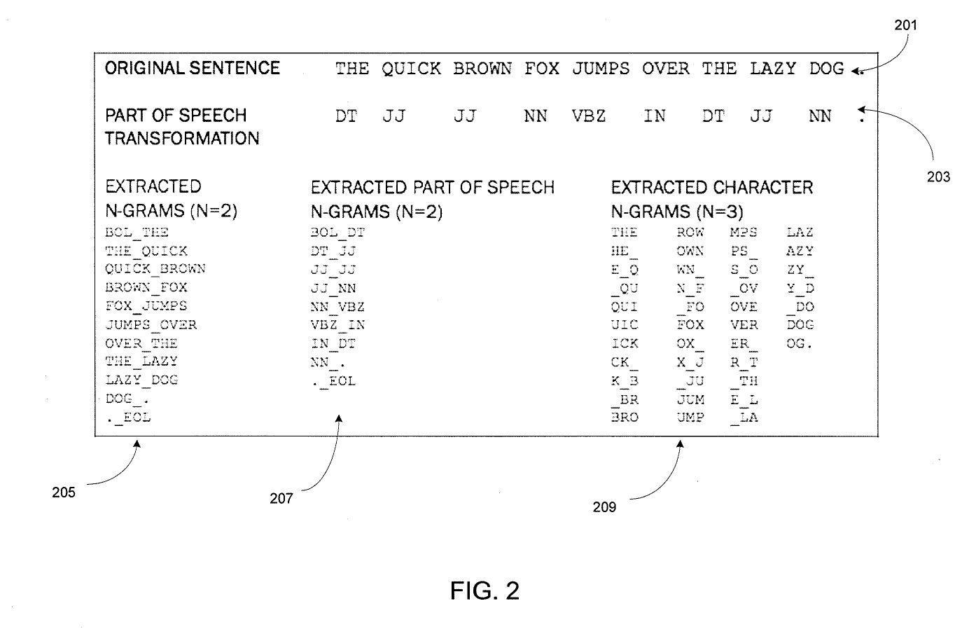

FIG. 2 demonstrates three possible configurations for n-gram extraction from an input text 201. In the first configuration 205 of this example, a word n-gram extractor uses the raw input text as source representation, treats each word as an atomic unit, and sets n=2. In common parlance this is called a “word bigram” representation. The second configuration 207 assumes that the input text 201 has been converted into a syntactic part-of-speech representation, using a set of potential parts of speech labels 203, while the other two parameters remain fixed. The atomic granularity remains the word, while the length is set to 2 (the “part-of-speech bigram” representation). The final configuration 209 assumes that the atomic granularity has changed. Instead of extracting words as the base unit of analysis the method and system now extracts sequences of individual characters. The source representation reverts to the raw text as in the first example, and the length n is changed to 3 (the “character trigram” representation). In these embodiments, the features need not be ranked, ordered or considered in any context.

The potential number of features that are generated through these extractors may very large. In traditional automated essay grading as few as 12 features have been used, making the task tractable for comparatively slow and simple algorithms like linear regression. In contrast, a prompt-dependent, dynamic, and generative representation as described in this document can include any number of features in its assessment, such as thousands of features. Thus, in the present embodiments, linear regression may not be a suitable algorithm for determining a score class given a set of features. A different score assignment algorithm will typically be used in the present embodiments.

Feature Filtering:

Prior to predicting a class value, some filtering of features may be desirable. Because of the preponderance of features that can be generated using automated feature extraction, many features may be too rare or too uninformative to be worth estimating. In one embodiment of this method and system, this filtering step can be performed through (1) discarding all features that do not appear in a minimum threshold number of documents in a set of training essays, or in a minimum percentage of the documents in the set, and (2) calculating the chi-squared test statistic for a feature in regard to a discrete set of class values, and discarding all features which fall below a certain threshold, either by (a) setting a floor on the allowable chi-squared test statistic, or (b) setting a ceiling on the total number of extracted features allowed for estimation. Other filtering processes are possible.

To illustrate this example of filtering, consider a training corpus of 500 documents. The following list is an initial extracted feature set comprised of 12 unigrams, with corresponding document counts (i.e., the number of documents in the training corpus where that feature's value did not equal 0):

AND: 13

WHY: 12

FOX: 10

OVER: 10

ANACONDA: 8

CANDELABRA: 6

BULLDOZER: 3

OR: 3

DAFFODIL: 2

NOT: 2

ENDOCRINE: 1

THE: 1

In this example corpus, a feature filter that simply removed features below a frequency of 5 would result in only features above the line in this list, resulting in 6 features instead of the original 12.

Classification (Assigning Probabilities):

One method by which the system may assign probabilities to various parameters of a corpus of documents is by use of the Naïve Bayes classification algorithm. In this example we will assume labels for mathematical representation, namely a set of features X and a class Y (including a set of possible class labels y₁, y₂, etc.). When the system applies this algorithm to a data set for a corpus of documents, the system assigns a probability to each class label, and additionally to each combination of a feature, a feature value, and a class label.

For the purpose of this example, the system may consider the absence or presence of a feature to have a binary value, such that the value of a feature is equal to 1 if the feature is present in a text and 0 if it is not present. This is an embodiment of the unigram extractor—features can be given the shorthand of a name. A document may contain a given set of features, meaning that those features have a value of 1 for that document, and all other features from that extractor have a value of 0.

Then, the system may calculate the probability for a given feature Xᵢ given that the class y of a document is equal to a particular class label y_{c}. To do this, the system may use a maximum likelihood estimation:

P(xᵢ=1|y=y_{c})=

# essays in training corpus containing xᵢ where y=y_{c}/

# essays in training corpus where y=y_{c}.

This calculation can be performed for all values of xᵢ and all values of y_{c}. This builds a comprehensive set of probability estimates for each feature with regard to a class value. These probabilities now may estimate a feature's likelihood of appearing in essays that exhibit a given class value, rather than merely increasing or decreasing the final estimated output score.

Consider for instance the unigram feature “dog” and a set of class labels {PASS, FAIL}. Using Naïve Bayes estimation, the system will calculate four probabilities:

P(“dog”=1|y=PASS)

P(“dog”=0|y=PASS)

P(“dog”=1|y=FAIL)

P(“dog”=0|y=FAIL)

This probability notation also can be expressed through shorthand. For the purpose of this disclosure, we will write this notation as follows: P(feature|class), which corresponds to P(feature=1|y=class). In addition, the system may determine a probability for each class value P(C) based on the training corpus. For example, if 60% of the essays in a training corpus have received a passing grade, then the system may assign P(PASS)=0.6.

Because of the functioning of conditional probabilities, the total probability of each condition must sum to 1.0; that is, probabilities (a) and (b) above will have a total of 1.0, and probabilities (c) and (d) above will also have a total of 1.0. This means that our shorthand needs only to express the values of probabilities (a) and (c) above. If P(“dog”|PASS)=0.7, then we know that P(“dog”=0|y=PASS) must be equal to 0.3.

Prediction using a Naïve Bayes classifier is performed by multiplying these calculated probabilities. More formally, for a given input essay S and a feature set F comprised of features {f₁, f₂, etc.}, the calculation to be performed for each class label C may be:

P(S|C)=P(C)*Π_{f in F}P(f|C)

Because each probability is by definition equal to 1 at most, each subsequent multiplication of probabilities results in a smaller number. These numbers rapidly approach 0, and as such, accommodation for very small numbers must be considered in implementation. One option for managing these small numbers is through frequent normalization to a sum of 1. Because such normalization is monotonic, this does not affect the distribution of class value probabilities.

Prediction:

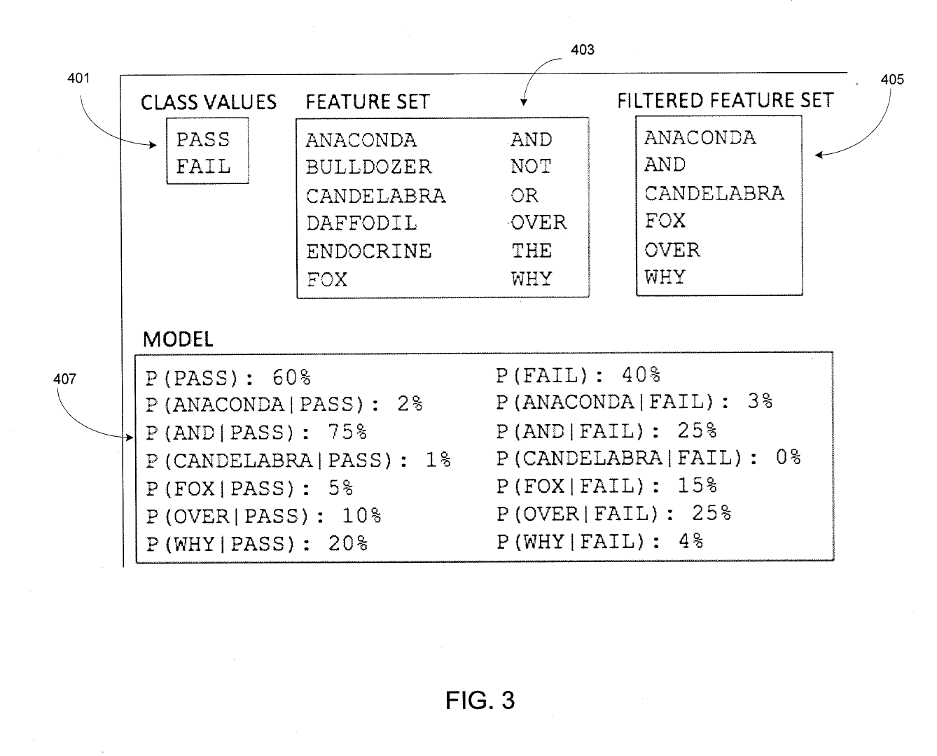

In a basic example of prediction, the system's classifier may receive a text (or results of analysis of a text) as input and predict a class value as a result. An example of this prediction process is shown through an example classifier in FIG. 3. Here, the classifier has already been trained, and a class 401 has been defined with two possible class labels: PASS and FAIL. An extractor has defined a feature set 403 that includes twelve unigram features from some prior training set. A filter has been defined that reduces that set of features to a filtered feature set 405 of six. Then, the system has applied a Naïve Bayes classifier to generate a set of probabilities 407 associated with each class, as well as with each feature conditioned on a class for each document that contains some or all of the filtered feature set.

A few things may be noted in this representation. The original training data no longer needs to be maintained once a classifier has been built. The feature set has been defined and the model has assigned probabilities to those features tied to class labels, so the source material need not be referenced at prediction time. This is useful for implementation of systems where computer memory is limited, or the source material is located remote from the processing system.

Now consider that a sample sentence S passes through this classifier:

THE QUICK BROWN FOX JUMPS OVER THE LAZY DOG

This sentence contains only two features that were maintained in the final, filtered feature set: OVER and FOX. Both features are given values of 1 for this document; the remaining four features are given values of 0. The system may then determine a probability of each class value using the Naïve Bayes classifier:

P(S|PASS)=P(PASS)

*P(ANACONDA=0|Y=PASS)

*P(AND=0|Y=PASS)

*P(CANDELABRA=0|Y=PASS)

*P(FOX=1|Y=PASS)

*P(OVER=1|Y=PASS)

*P(WHY=0|Y=PASS)

P(S|FAIL)=P(FAIL)

*P(ANACONDA=0|Y=FAIL)

*P(AND=0|Y=FAIL)

*P(CANDELABRA=0|Y=FAIL)

*P(FOX=1|Y=FAIL)

*P(OVER=1|Y=FAIL)

*P(WHY=0|Y=FAIL)

The values in these equations can then be retrieved through a function such as lookup in the trained classifier. Whenever a feature value of F=0 is be looked up for a class C, rather than storing it directly it can be calculated as 1−P(F=1|Y=C).

P(S|PASS)=*0.60*0.98*0.25*0.99*0.05*0.10*0.80=0.00058212

P(S|FAIL)=*0.40*0.97*0.75*1.00*0.15*0.25*0.96=*0.010476

Finally, these sums may be normalized such that the total probability of all class values equals 1:

P(S|PASS)=0.00058212/(0.00058212+0.010476)=0.052642

P(S|FAIL)=0.010476/(0.00058212+0.010476)=0.947358

The classifier then predicts, based on this set of features and this trained model, a class value of FAIL. Moreover, we know that the classifier assigns approximately a 94.7% confidence to this prediction, because that percentage equals the normalized probability that the class value will be FAIL for the candidate sentence.

The system may use other, more complex, classifiers, comprising any number features and, usually, more than two class values. The same methods may apply at this scale. Additionally, when prediction for multiple classes is involved, the corresponding classifiers may be used in parallel and do not need to interact. This allows the system to be used for multiple assessments, predicted for the same input document, with no loss of generality for the overall workflow described above.

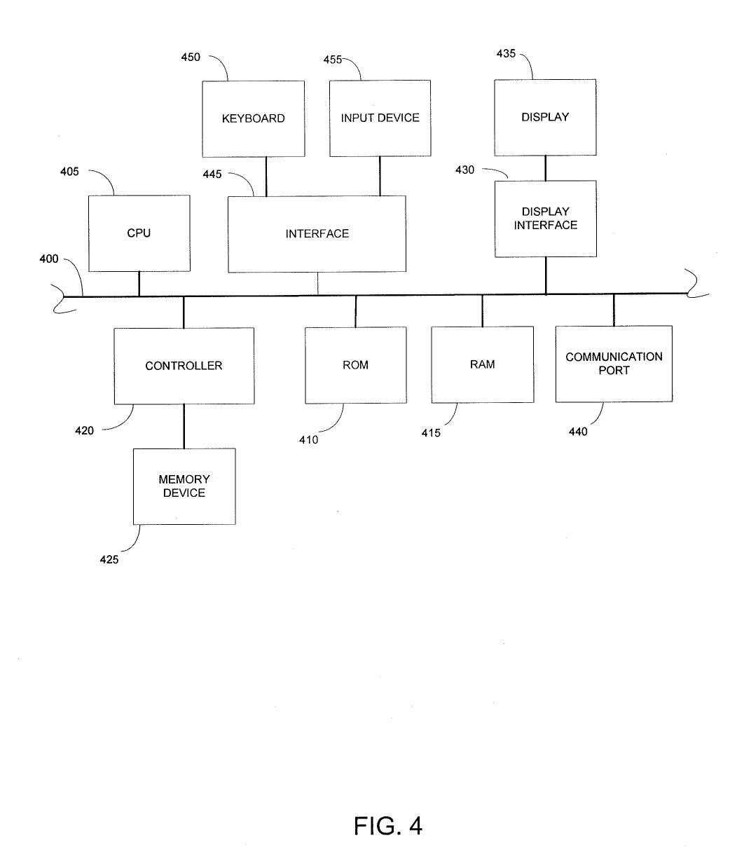

FIG. 4 depicts an example of internal hardware that may be used to contain or implement the various computer processes and systems as discussed above. An electrical bus 400 serves as an information highway interconnecting the other illustrated components of the hardware. CPU 405 is a central processing unit of the system, performing calculations and logic operations required to execute a program. CPU 405, alone or in conjunction with one or more of the other elements disclosed in FIG. 4, is a processing device, computing device or processor as such terms are used within this disclosure. Read only memory (ROM) 410 and random access memory (RAM) 415 constitute examples of memory devices. The processor may execute programming instructions that are stored in one of the memory devices to implement the methods described above. When used in this document, the term “processor” may include either a single processing device or two or more processing devices that collectively perform a set of functions. For example, in the embodiments described above, one or more first processors may build the model and cause the model to be stored in a data storage facility, while a second processor may receive a candidate essay, access the model, and apply the model to the candidate essay to predict a class value for the essay.

A controller 420 interfaces with one or more optional memory devices 425 that service as data storage facilities to the system bus 400. These memory devices 425 may include, for example, an external disk drive, a hard drive, flash memory, a USB drive or another type of device that serves as a data storage facility. As indicated previously, these various drives and controllers are optional devices. Additionally, the memory devices 425 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 410 and/or the RAM 415. Optionally, the program instructions may be stored on a tangible computer readable medium such as a compact disk, a digital disk, flash memory, a memory card, a USB drive, an optical disc storage medium, a distributed computer storage platform such as a cloud-based architecture, and/or other recording medium.

A display interface 430 may permit information from the bus 400 to be displayed on the display 435 in audio, visual, graphic or alphanumeric format. Communication with external devices may occur using various communication ports 440. A communication port 440 may be attached to a communications network, such as the Internet, a local area network or a cellular telephone data network.

The hardware may also include an interface 445 which allows for receipt of data from input devices such as a keyboard 450 or other input device 455 such as a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A computer-implemented method of predicting a grade or score for an essay comprising, by one or more processors:
receiving a corpus of training essays, wherein each essay is a response to a common prompt;
for each training essay:
receiving a human assessment for the training essay, wherein the human assessment comprises a class value that comprises a grade or score of the training essay, and
using one or more extractors to extract a plurality of feature values for each of a plurality of features;
building a model by assigning a probability to each of a plurality of combinations of the class values and feature values for the training essays;
receiving a candidate essay;
extracting a set of feature values from the candidate essay;
applying the model to the feature values extracted from the candidate essay to determine a probable class value for the candidate essay so that the probable class value comprises a machine-generated predicted grade or score for the candidate essay; and
outputting the predicted grade or score of the probable class value.

2. The method of claim 1, further comprising:
before building the model, applying a filter to features for which feature values were extracted from the training essays to remove the features having feature values that do not satisfy a retention criterion; and
using only feature values for the non-removed features in the building step.

3. The method of claim 2, wherein applying the filter comprises removing the features having feature values that are less than a threshold, wherein the threshold is a measure of:
a number of essays in the corpus that contain the feature;
a percentage of the essays in the corpus that contain the feature; or
a chi-squared test statistic.

4. The method of claim 1, wherein building the model comprises applying a Naïve Bayes classifier to assign the probabilities.

5. The method of claim 1, wherein applying the model comprises:
for each of a plurality of candidate grades or scores for the corpus of training essays, determining a probability that the grade or score will appear in the corpus in combination with a particular feature value; and
selecting the probable grade or score as the candidate grade or score having the highest determined probability.

6. The method of claim 1, wherein applying the model comprises:
for each of a plurality of candidate grades or scores for the corpus of training essays, determining a probability that the grade or score will appear in the corpus in combination with a particular feature value;
for each of the plurality of candidate grades and scores, determining a confidence value for the probability;
selecting the probable grade or score as the candidate grade or score having the highest determined confidence value.

7. The method of claim 2, wherein:
applying the filter comprises removing the features having feature values that are less than a threshold, wherein the threshold corresponds to a measure of essays in the corpus that contain the feature; and
applying the model comprises:
for each of a plurality of candidate class values for the corpus of training essays, determining a probability that the class value will appear in the corpus in combination with each feature value of the features that were not removed in the filtering, and
selecting the probable class value from the candidate class values based on the determined probabilities for each candidate class value.

8. The method of claim 1, wherein:
extracting the feature values from each training essay comprises:
applying n-gram extraction to extract a plurality of n-grams from text of each of the training essays, wherein n is an cardinal number, and
filtering the n-grams to yield a filtered n-gram set;
extracting the set of feature values from the candidate essay comprises, for each n-gram in the filtered n-gram set, determining whether the n-gram is present in the document, and assigning a binary value to the n-gram for the candidate essay based on whether or not the n-gram is present; and
assigning the probabilities uses the binary value for each n-gram as the feature values.

9. A computer-implemented method of predicting a grade or score for an essay comprising, by one or more processors:
receiving a corpus of training essays, wherein each essay is a response to a common prompt;
for each training essay:
receiving a human assessment for the training essay, wherein the human assessment comprises a class value that comprises a grade or score of the training essay, and
using one or more extractors to extract a plurality of feature values for each of a plurality of features;
building a model by assigning a probability to each of a plurality of combinations of the class values and feature values; and
saving the model to a data storage facility.

10. The method of claim 9, further comprising
before building the model, applying a filter to features for which feature values were extracted from the training essays to remove the features having feature values that do not satisfy a retention criterion, and using only feature values for the non-removed features in the building step; and
after saving the model:
receiving a candidate essay;
extracting a set of feature values from the candidate essay;
applying the model to the feature values extracted from the candidate essay to determine a probable class value for the candidate essay so that the probable class value comprises a machine-generated predicted score or grade for the candidate essay,
wherein applying the model comprises, for each of a plurality of candidate class values for the corpus of training essays, determining a probability that the class value will appear in the corpus in combination with a particular feature value, and using the determined probabilities to select the one of the candidate class values as the probable class value, and
wherein the probable class value comprises a machine-generated predicted score or grade for the candidate essay; and
outputting the predicted score or grade of the probable class value.

11. An essay classification system for predicting a grade or score of an essay, comprising:
one or more processors; and
a non-transitory computer-readable memory portion containing programming instructions that, when executed, instruct one or more of the processors to:
receive a corpus of training essays, wherein each essay is a response to a common prompt;
for each training essay:
receive a class value for the training essay, wherein the class value comprises a score or grade that resulted from human evaluation of the training essay, and
extract a plurality of feature values for each of a plurality of features;
build a model by assigning a probability to each of a plurality of combinations of the class values and feature values; and
save the model to a data storage facility.

12. The system of claim 11, further comprising a non-transitory computer readable memory portion containing additional programming instructions that, when executed, cause one or more of the processors to:
receive a candidate essay;
extract a set of feature values from the candidate essay;
apply the model to the feature values extracted from the candidate essay to determine a probable class value for the candidate essay so that the probable class value comprises a machine-generated predicted score or grade for the candidate essay; and
output the probable class value.

13. The system of claim 11, further comprising additional programming instructions that, when executed, cause one or more of the processors to:
before building the model, apply a filter to features for which feature values were extracted from the training essays to remove the features having feature values that do not satisfy a retention criterion; and
use only feature values for the non-removed features in the building step.

14. The system of claim 13, wherein the instructions to apply the filter comprise instructions to remove the features having feature values that are less than a threshold, wherein the threshold is a measure of:
a number of essays in the corpus that contain the feature;
a percentage of the essays in the corpus that contain the feature; or
a chi-squared test statistic.

15. The system of claim 11, wherein the instructions to build the model comprise instructions to apply a Naïve Bayes classifier to assign the probabilities.

16. The system of claim 12, wherein the instructions to apply the model comprise instructions to:
for each of a plurality of candidate class values for the corpus of training essays, determine a probability that the candidate class value will appear in the corpus in combination with a particular feature value; and
select the probable class value as the candidate class value having the highest determined probability.

17. The system of claim 12, wherein the instructions to apply the model comprise instructions to:
for each of a plurality of candidate class value for the corpus of training essays, determine a probability that the candidate class value will appear in the corpus in combination with a particular feature value;
for each of the plurality of candidate class values, determine a confidence value for the probability; and
select the probable class value as the candidate class value having the highest determined confidence value.

18. The system of claim 13, wherein:
the instructions to apply the filter comprise instructions to remove the features having feature values that are less than a threshold, wherein the threshold corresponds to a measure of essays in the corpus that contain a feature having feature values that are less than the threshold; and
the instructions to apply the model comprise instructions to:
for each of a plurality of candidate class value for the corpus of training essays, determine a probability that the candidate class value will appear in the corpus in combination with each feature value of the features that were not removed in the filtering, and
select the probable class value from the candidate class values based on the determined probabilities for each candidate class value.

19. The system of claim 12, wherein:
the instructions to extract the feature values from each training essay comprise instructions to:
apply n-gram extraction to extract a plurality of n-grams from text of each of the training essays, wherein n is an cardinal number, and
filter the n-grams to yield a filtered n-gram set;
the instructions to extract the set of feature values from the candidate essay comprise instructions to, for each n-gram in the filtered n-gram set:
determine whether the n-gram is present in the document,
assign a binary value to the n-gram for the candidate essay based on whether or not the n-gram is present, and
assign the probabilities uses the binary value for each n-gram as the feature values.

20. The system of claim 11, wherein
the instructions further comprise instructions to:
before building the model:
apply a filter to features for which feature values were extracted from the training essays to remove the features having feature values that do not satisfy a retention criterion, and
use only feature values for the non-removed features in the building step; and
after saving the model:
receive a candidate essay;
extract a set of the feature values from the candidate essay;
apply the model to the feature values extracted from the candidate essay to determine a probable class value for the candidate essay by, for each of a plurality of candidate class values for the corpus of training essays, determining a probability that the class value will appear in the corpus in combination with a particular feature value, and using the determined probabilities to select one of the candidate class values as the probable class value; and
output the probable class value as the predicted score or grade.
